(19) United States
(12) Patent Application Publication
(10) Pub. No.: US 2008/0107827 A1
(43) Pub. Date: May 8, 2008

(54) Diffusing structure

(75) Inventors: Thomas Bertin-Mourot, Paris (FR); Aurelia Prat, Ruislip (GB)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/563,000

(22) PCT Filed: Jul. 2, 2004
(86) PCT No.: PCT/FR04/01717

§ 371 Date: May 10, 2006

(30) Foreign Application Priority Data
Jul. 2, 2003 (FR) 03/08022

(51) Int. Cl. G02B 5/02; F21V 9/06; G02B 5/22; G02F 1/133

(52) U.S. Cl. 428/1.1; 428/220; 428/323; 428/411.1; 428/457

(57) ABSTRACT

According to the invention, the diffusing structure comprises at least one diffusing layer intended to make a light source uniform and comprises at least one thermoplastic sheet designed to filter out part of the electromagnetic wave spectrum of said light source.

The invention also relates to uses for the production of backlighting and/or projection systems or of flat lamps.

The invention relates to improvements made to a diffusing structure in order to make a light source uniform and to filter it.

Although the invention is not limited to such applications, it will be more particularly described with reference to diffusing structures used for making the light emitted from a backlighting system uniform.

Such a system may especially be a light source or backlight used especially as backlighting source for liquid-crystal screens.

The invention may also be used when it is desired to make the light coming from architectural flat lamps uniform, these lamps being used for example on ceilings, floors or walls. They may also be flat lamps for municipal use, such as advertising panel lamps or else lamps that can constitute shelves or back walls of display windows.

The light sources used in these backlighting systems are mainly lamps or discharge tubes commonly called CCFLs (Cold Cathode Fluorescent Lamps), HCFLs (Hot Cathode Fluorescent Lamps) or DBDFLs (Dielectric Barrier Discharge Fluorescent Lamps).

Certain LCD screens of the prior art incorporate:
a thick (about 2 mm) plastic diffuser, generally made of PMMA or polycarbonate;
various optical plastic films fulfilling functions for making the light uniform or for shaping it or for diffusion; and
a reflective polarizer.

It has been found that the diffuser rapidly turns a yellowish color so that the desired transparency criteria are no longer met.

The object of the present invention is therefore to alleviate these drawbacks by proposing a diffusing structure that combines long life with good optical performance.

For this purpose, the invention provides a diffusing structure which comprises a diffusing layer intended to make a light source uniform and which comprises at least one thermoplastic sheet designed to filter out part of the electromagnetic wave spectrum of said light source.

The Applicant has found that it is the ranges of high-energy waves, and more particularly the ultraviolet waves, which tend to degrade the optical plastic films and thus attenuate their performance.

Thus, the thermoplastic sheet according to the invention provides effective protection of all the sensitive elements, especially the optical elements, namely diffusing plastic film(s), reflective polarizer, etc., from the harmful radiation. Furthermore, this sheet does not yellow.

The diffusing structure according to the invention is therefore a particularly attractive filtering diffusing structure.

The thermoplastic sheet may receive the electromagnetic radiation from the light source before or after it passes into a glass substrate (which is largely insensitive to UV-type radiation) that carries the diffusing, for example essentially mineral, layer (also largely insensitive to UV-type radiation) and/or that carries one or more plastic films to be protected, acting as additional diffusing layer or as a substitute for the essentially mineral diffusing layer.

The thermoplastic sheet may also receive the electromagnetic radiation from the light source directly or via a waveguide depending on the screen configurations.

Furthermore, this thermoplastic sheet is preferably chosen so as not to appreciably modify the optical characteristics of the structure in the visible.

Advantageously, the thermoplastic sheet can be designed to filter in the wave range between 0.28 μm and 0.40 μm.

In a preferred embodiment, this structure comprises at least one essentially mineral element, preferably a glass substrate, and/or said diffusing layer.

The mineral element is largely UV-insensitive and therefore allows, in combination with the filtering thermoplastic sheet, an even greater latitude as regards the multilayers (diffusing layer, polymeric optical film(s), etc.) forming the structure compared with an “all organic” solution.

A glass substrate provides good mechanical endurance, especially resistance to the heat emitted by the light source.

Moreover, for large screens, the diagonal of which is greater than 10″ (25 cm) (the diagonal being in this case a characteristic dimension of the screen), the light sources are located inside an enclosure as close as possible to the diffusing part (“direct light”-type structure), which is generally not the case for small screens (diagonal less than 10″) for which the light sources are positioned along the side of the enclosure (“edge light”-type structure), the light being conveyed toward the diffusing layer by a waveguide. The heat generation is therefore particularly substantial.

For these large screens, this heat generation may result in structural deformation of a conventional plastic diffusing layer, which deformation is manifested by the brightness of the image projected onto the screen being non-uniform.

A mineral diffusing layer combined with a glass substrate is particularly heat-resistant.

The thermoplastic sheet may preferably be based on PVB.

In preferred embodiments of the invention, one or more of the following provisions may optionally also be used:
the diffusing structure further comprises a reflective polarizer, of the birefringent multilayer type, disperse birefringent phase type, cholesteric liquid-crystal type or wire-grid type;
the diffusing structure further comprises a plastic sheet coated with a transparent metal oxide layer;
the diffusing structure comprises a plastic sheet for controlling the viewing angle or for shaping the light, of the CH27 or BEF type; and
the diffusing structure comprises the LCD matrix assembly.

In one advantageous embodiment, the thermoplastic sheet is a lamination interlayer.

In this way, it is possible to produce a fairly thin laminated filtering diffusing structure, especially by hot rolling, which comprises for example:
a glass substrate;
the thermoplastic, preferably PVB, sheet;
one or more optical (diffusing, etc.) plastic films;
optionally, a reflective polarizer;
   or:
a mineral diffusing layer;
a glass substrate;
the thermoplastic, preferably PVB, sheet;
a reflective polarizer;
   or else:
a mineral diffusing layer;
a glass substrate;
the thermoplastic, preferably PVB, sheet;
one or more optical (diffusing, etc.) plastic films;
a reflective polarizer.

In a preferred embodiment, the diffusing structure incorporates a substrate, and the diffusing layer is deposited on one of the faces of said substrate, whereas the thermoplastic sheet is deposited on the opposite face of said substrate.

The diffusing layer may comprise a diffusing plastic film, for example made of PET, which is preferably thin, for example less than 400 μm and more preferably around 100 μm.

In one embodiment, the diffusing layer may also comprise a diffusing layer composed of elements containing particles and a binder, the binder allowing the particles to agglomerate.

In the latter embodiment:
the particles may be metal or metal oxide particles;
the size of the particles may be between 50 nm and 1 μm; and
preferably, the binder may be a mineral binder for heat resistance.

According to one feature of the invention, the diffusing structure may have a thickness substantially between 0.5 and 3 mm.

For example, a diffusing mineral layer of about 10 μm, a glass substrate of about 2 μm, a thermoplastic sheet of about 500 μm and a diffusing plastic film or polarizer of about 100 μm are chosen.

The diffusing structure may incorporate a coating having a functionality other than that of filtering out part of the electromagnetic wave spectrum emitted by said light source, especially a coating having a low-emissivity, antistatic function, an antifogging function or an antisoiling function.

In a first embodiment, the structure comprises a glass substrate on which the diffusing layer and said sheet are placed, the glass substrate having a light transmission TL of not less than 90% and preferably not less than 91.5% (called extra-clear glass).

The reader may refer to application WO04/025334 for the glass composition and the advantages (recycling, etc.) of the extra-clear glass.

In a second embodiment, the structure comprises a transparent polymer-based substrate on which the diffusing layer and said sheet are placed, the substrate being for example made of polycarbonate or PMMA.

Thus, this substrate is protected by the thermoplastic sheet according to the invention.

In a third embodiment, the thermoplastic sheet is a transparent substrate on which the diffusing layer is placed.

According to another aspect, the subject of the invention is the use of a diffusing structure as described above in a backlighting or projection system.

In preferred embodiments of the invention, one or more of the following provisions may optionally also be used:
the substrate is one of the glass sheets constituting the backlighting and/or flat lamp system;
the substrate possesses a characteristic dimension suitable for direct-light applications.

Other advantages and features of the invention will become apparent in the light of the detailed description that follows.

Within the context of the invention, the term “diffusing layer” is understood to mean any layer functionally adapted to diffuse light, whatever its structure.

In a first embodiment of the invention, the diffusing layer consists of agglomerated particles in a binder, said particles having a mean diameter of between 0.3 and 2 microns, said binder being in a proportion of between 10 and 40% by volume and the particles forming aggregates, the size of which is between 0.5 and 5 microns, said layer having a contrast attenuation of greater than 40% and preferably greater than 50%.

This preferred diffusing layer is described in particular in application WO 0190787.

The particles are chosen from semitransparent particles and preferably mineral particles, such as oxides, nitrides and carbides.

The particles will be preferably chosen from the oxides of silica, alumina, zirconia, titanium and cerium, or from a mixture of at least two of these oxides.

Such particles may be obtained by any means known by those skilled in the art and especially by precipitation or by pyrolysis. The particles have a particle size such that at least 50% of the particles depart by less than 50% from the mean diameter.

The binder has a temperature resistance sufficient to resist the operating temperatures and/or the temperature at which the lamp is sealed if the layer is produced before assembly of the lamp and especially before the latter is sealed.

When the layer is in an external position, the binder is also chosen to have an abrasion resistance sufficient to undergo, without being damaged, all the operations involved in handling the backlighting system, for example in particular when mounting the flat screen.

Depending on the requirements, the binder may be chosen to be a mineral binder, for example in order to enhance the temperature resistance of the layer, or an organic binder, especially to simplify the production of said layer, which can be crosslinked simply, for example at room temperature. The choice of a mineral binder, whose temperature resistance is high, will especially allow the production of backlighting of very long lifetime without any risk of visible degradation of the layer, for example due to the fluorescent tubes that cause considerable heating.

The binder possesses an index different from that of the particles and the difference between these two indices is preferably at least 0.1. The index of the particles is greater than 1.7 and that of the binder is preferably less than 1.6.

The binder is chosen from potassium silicates, sodium silicates, lithium silicates, aluminum phosphates, polymers of the polyvinyl alcohol type, thermosetting resins, acrylics, etc.

To promote the formation of aggregates with the desired size, the invention provides for the addition of at least one additive resulting in a random distribution of the particles in the binder. Preferably, the additive or dispersion agent is chosen from the following agents: an acid, a base, or ionic polymers of low molecular weight, especially less than 50 000 g/mol.

It is also possible to add other agents, for example a wetting agent such as nonionic, anionic or cationic surfactants, in order to provide a layer that is uniform on a large scale.

It is also possible to add rheology modifiers, such as cellulose ethers.

The layer thus defined may be deposited with a thickness of between 1 and 20 microns. The methods used to deposit such a layer may be any means known to those skilled in the art, such as deposition by screen printing, by coating with a paint, by dip coating, by spin coating, by flow coating, by spraying, etc.

When the desired thickness of the deposited layer is greater than 2 microns, a deposition process of the screen printing type is used.

When the thickness of the layer is less than 4 microns, the deposition is preferably carried out by flow coating or by spraying.

Provision is also made to produce a layer whose thickness varies depending on the region of coverage on the surface; such an embodiment may allow intrinsic inhomogeneities of a light source to be corrected. For example, it is possible in this way to correct the variation in illumination of light sources along their length. In another embodiment resulting in substantially the same effect, namely the correction of intrinsic inhomogeneities of light sources, provision is made to produce a layer whose density of coverage varies over the coating surface; for example, this may be a screen-printed coating whose density of points may vary from a completely covered region to a region of dispersed points, the transition being gradual or otherwise.

According to yet another embodiment, the diffusing layer may be obtained from a glass substrate that has undergone a surface treatment. This may for example be a sandblasted substrate, a substrate that has undergone acid etching, sold by Saint-Gobain Glass France under the name Satinovo™, or a substrate coated with an enamel layer, sold by Saint Gobain Glass France under the names Emalit™ or Opalit™.

In another embodiment, the diffusing layer may comprise a thin diffusing plastic film. This may for example be one of the diffusing films sold by 3M™ under the reference numbers 3635-30 or 3635-70.

Whatever the embodiment of the diffusing layer, the latter is combined with at least one thermoplastic sheet designed to filter out part of the electromagnetic wave spectrum of said light source. This thermoplastic sheet may be adapted to perform a selection within the electromagnetic wave spectrum emitted by a light source.

In the present application, the wave range selected lies in the ultraviolet range, namely 0.28 to 0.40 μm.

The thermoplastic sheet or film may be made of clear PVB, such as for example the product named Saflex sold by Solutia, or an equivalent film.

This filtering device is preferably positioned as close as possible to the diffusing layer.

This thermoplastic film is therefore combined with a diffusing layer, the assembly being combined with a substrate, especially one of glass or polymer (PMMA, polycarbonate) in order to give a filtering diffusing structure.

This combining with the substrate may be carried out in several ways:
the diffusing layer covers one of the faces of the substrate, the thermoplastic film itself covering the other face,
the diffusing layer covers one of the faces of the substrate, the thermoplastic film is combined with at least one other film providing the system with another functionality before the combination covers the other face of the substrate, and the thermoplastic film may be combined directly or indirectly with all or part of the following other films:
a reflective polarizer of the birefringent multilayer type (based on polyethylene naphthalate or PEN (for example a DBEF film sold by 3M),
a reflective polarizer of the disperse birefringent phase type,
a reflective polarizer of the cholesteric liquid-crystal type (for example based on liquid crystals sold by Merck, 3M, Nitto Denko or Wacker),
a reflective polarizer of the wire-grid type (for example those sold by Moxtek),
a plastic sheet coated with a transparent metal oxide layer (for example a layer of ITO (indium tin oxide) deposited on a PET substrate),
a plastic sheet for shaping the light or allowing the viewing angle to be controlled (for example a sheet of the BEF brand, sold by 3M, or that of the CH27 brand sold by SKC).

Whatever the configuration of the combination formed by the substrate, the diffusing layer combined with the thermoplastic film designed to filter out part of the electromagnetic wave spectrum, or else the diffusing layer combined both with the thermoplastic film designed to filter out part of the electromagnetic wave spectrum and at least one other film providing another functionality, the filtering diffusing structure has a light transmission T_{L} of at least 20% and preferably greater than 50%, and a light absorption A_{L} of less than 15%. The thickness of the diffusing layer thus formed is substantially between 0.5 and 3 mm.

An alternative embodiment, which may be combined with the embodiments of filtering diffusing structures described above, consists in incorporating a coating having another functionality. This may be a coating having the function of blocking radiation of wavelengths in the infrared (for example using one or more silver layers surrounded by dielectric layers, or layers made of nitrides such as TiN or ZrN or made of metal oxides or of steel or an Ni—Cr alloy), with a low-emissivity function (for example made of a doped metal oxide, such as F: SnO₂ or tin-doped indium oxide ITO or one or more silver layers), a heating layer (doped metal oxide, Cu, Ag for example) or network of heating wires (copper wires or screen-printed strips using a conductive silver paste), antifogging function (using a hydrophilic layer) or antisoiling function (photocatalytic coating comprising TiO₂, at least partly crystallized in anatase form).

The applications envisaged by the invention are especially backlighting systems, for example those used for illuminating liquid-crystal screens, or else flat lamps used for architectural lighting, or else municipal lighting, or more generally in any system incorporating light sources liable to generate electromagnetic interference. Such a flat lamp is described in document WO2004/015739.

According to another alternative embodiment relating to the use of improved diffusing structures according to the invention in the production of a backlighting system, the diffusing layer and the other films are deposited on a transparent or semitransparent substrate independent of the glass sheets constituting the structure of the backlighting system.

Such an embodiment may consist in depositing the combination of layers on a glass substrate held at a certain distance from the front face of the backlighting system; this embodiment makes it possible, through the laws of physics, to further improve the diffusing effect of the multilayer assembly. As a downside, the volume or size of such an embodiment is greater, but the optical performance is even more durable over time.

The improved filtering diffusing structures thus presented according to the invention therefore make it possible to produce backlighting systems that are intended for example for the lighting of liquid-crystal screens.

The filtering diffusing structure according to the invention may allow the size of a backlighting system to be reduced for a given performance in terms of luminance, brightness and lifetime.

In another embodiment example, the filtering diffusing structure is composed successively of a mineral diffusing layer deposited on an extra-clear glass substrate, laminated with the thermoplastic sheet onto which a reflective polarizer or a diffusing film, such as those described above, is laminated.

In another embodiment example, the filtering diffusing structure is composed successively of an extra-clear glass substrate laminated with the thermoplastic sheet according to the invention, on which a diffusing plastic film as described above is laminated.

An extra-clear glass of the Satinovo range from Saint-Gobain may be chosen.

1. A diffusing structure comprising at least one diffusing layer intended to make a light source uniform and at least one thermoplastic sheet designed to filter out part of the electromagnetic wave spectrum of said light source.

2. The diffusing structure as claimed in claim 1, wherein the at least one thermoplastic sheet is designed to filter in the wave range of from 0.28 μm to 0.40 μm.

3. The diffusing structure as claimed in claim 1 further comprising at least one essentially mineral element.

4. The diffusing structure as claimed in claim 1, further comprising a PVB-based thermoplastic sheet.

5. The diffusing structure as claimed in claim 1, further comprising a reflective polarizer selected from the group consisting of birefringent multilayers, disperse birefringent phases, and cholesteric liquid crystals, and combinations thereof.

6. The diffusing structure as claimed in claim 1, further comprising a reflective polarizer of the wire-grid type.

7. The diffusing structure as claimed in claim 1, further comprising a plastic sheet coated with a transparent metal oxide layer.

8. The diffusing structure as claimed in claim 1, further comprising a plastic sheet for controlling the viewing angle or for shaping the light.

9. The diffusing structure as claimed in claim 1, wherein the at least one thermoplastic sheet is a lamination interlayer.

10. The diffusing structure as claimed in claim 1, further comprising an LCD matrix assembly.

11. The diffusing structure as claimed in claim 1, further comprising a substrate, wherein the at least one diffusing layer is deposited on one of the faces of said substrate, and wherein the at least one thermoplastic sheet is deposited on the opposite face of said substrate.

12. The diffusing structure as claimed in claim 1, wherein the at least one diffusing layer comprises a diffusing plastic film.

13. The diffusing structure as claimed in claim 1, wherein the at least one diffusing layer comprises a diffusing layer comprising particles and a binder, wherein the binder allows the particles to agglomerate.

14. The diffusing structure as claimed in claim 13, characterized in that the particles are metal or metal oxide particles.

15. The diffusing structure as claimed in claim 13, wherein the size of the particles is from 50 nm to 1 μm.

16. The diffusing structure as claimed in claim 13, wherein the binder is a mineral binder.

17. The diffusing structure as claimed claim 1, wherein the diffusing structure has a thickness of from 0.5 to 3 mm.

18. The diffusing structure as claimed in claim 1, wherein the diffusing structure further comprises a coating comprising a function selected from the group consisting of these having a low-emissivity function, an antistatic function, an antifogging function, of an antisoiling functions and a combination thereof.

19. The diffusing structure as claimed in claim 1, further comprising a glass substrate on which the at least one diffusing layer and sax the at least one thermoplastic sheet are placed, the wherein the glass substrate comprises a light transmission T_{L} of not less than 90%.

20-23. (canceled)

24. The diffusing structure as claimed in claim 2, further comprising a reflective polarizer selected from the group consisting of birefringent multilayers, disperse birefringent phases, cholesteric liquid crystals, and combinations thereof.
